(19) United States
(12) Patent Application Publication
(10) Pub. No.: US 2025/0238974 A1
(43) Pub. Date: Jul. 24, 2025

(54) COLORIZING VISUAL CONTENT USING ARTIFICIAL INTELLIGENCE MODELS

(71) Applicants: DISNEY ENTERPRISES, INC., Burbank, CA (US); ETH Zürich (Eidgenössische Technische Hochschule Zürich), Zürich (CH)

(72) Inventors: Abdelaziz DJELOUAH, Zürich (CH); Vukasin BOZIC, Zürich (CH); Christopher Richard SCHROERS, Uster (CH); Radu TIMOFTE, Gerbrunn (DE); Yang ZHANG, Dubendorf (CH); Markus Hans GROSS, Herrliberg (CH)

(21) Appl. No.: 19/034,899

(22) Filed: Jan. 23, 2025

Related U.S. Application Data
(60) Provisional application No. 63/624,065, filed on Jan. 23, 2024.

(51) Int. Cl. G06T 11/00

(52) U.S. Cl. CPC G06T 11/001

(57) ABSTRACT

Embodiments of the present disclosure provide techniques for colorizing visual content using artificial intelligence models. An example method generally includes receiving an image and an input prompt specifying a colorization to apply to the image. Based on an encoded version of the image and a textual description of the image input into a machine learning model, one or more color maps associated with the specified colorization to apply to the image are generated. A colorized version of the image is generated by a generative artificial intelligence model based on combining a grayscale version of the image and the one or more color maps, and the colorized version of the image is output.

### CROSS-REFERENCE TO RELATED APPLICATIONS

This application claims priority benefit of U.S. Provisional Patent Application titled “VERSATILE IMAGE AND VIDEO COLORIZATION USING VISION FOUNDATION MODELS,” Ser. No. 63/624,065, filed Jan. 23, 2024. The subject matter of this related application is hereby incorporated herein by reference.

### BACKGROUND

### Field of the Various Embodiments

Embodiments of the present disclosure relate generally to computer vision and machine learning and, more specifically, to techniques for image and video colorization using artificial intelligence models.

### DESCRIPTION OF THE RELATED ART

Colorizing visual content (e.g., images or video content) is a common problem in image restoration. Colorizing visual content may be performed for artistic purposes (e.g., to change the coloration of visual content), in restoring visual content captured in monochrome or with faded colors, and the like.

Various techniques exist for colorizing visual content. For example, the use of color hints in the context of colorizing a single image or multiple frames in video content can be used to colorize visual content using a transformer model or other generative artificial intelligence models. In automatic colorization models, a convolutional neural network may be used to convert a colorization task to an object classification task, or transformer models can be used for image colorization. Generally, automatic colorization models may output a single or limited range of colorization tasks. Additionally, colorization models may not apply a correct or consistent colorization across an object (e.g., may apply different colors or different shades of the same color to different surfaces of the object).

Video colorization techniques may impose additional complexities in colorizing visual content. These complexities generally relate to temporal consistency across different frames of video content. Some techniques attempt to use condition-based techniques, optical flow techniques (e.g., colorizing objects based on the estimated speed by which different objects move across different frames of video content), or object instance tracking techniques (in which instances of objects in video content are identified and tracked across different frames of video content) to colorize images. However, techniques for colorizing frames in video content may result in inaccurate colorization being applied across frames. For example, objects may not retain the same color across frames, leading to shifting and inaccurate colorization of objects depicted in video content.

Thus, what is needed in the art are more effective techniques for colorizing visual content using artificial intelligence models.

### SUMMARY

One embodiment of the present disclosure sets forth techniques for colorizing visual content using artificial intelligence models. An example method generally includes receiving an image and an input prompt specifying a colorization to apply to the image. Based on an encoded version of the image and a textual description of the image input into a machine learning model, one or more color maps associated with the specified colorization to apply to the image are generated. A colorized version of the image is generated by a generative artificial intelligence model based on combining a grayscale version of the image and the one or more color maps, and the colorized version of the image is output.

One embodiment of the present disclosure sets forth techniques for training an artificial intelligence model to colorize visual content. An example method generally includes receiving a training data set of color images and corresponding grayscale images. The color images and the corresponding grayscale images are encoded into a latent space. A generative model is trained to generate an image based on the encoded color images and the encoded grayscale images, and the trained generative model is deployed.

One technical advantage of the disclosed techniques is that the disclosed techniques allow for flexible and accurate colorization of visual content spatially and temporally. The techniques discussed herein may allow for visual content to be colorized based on various inputs defining the colorization to apply to visual content or portions thereof, such as textual hints, color hints accompanying the visual content to be colorized, and the like. Further, the techniques discussed herein may allow for visual content to be colorized in a temporally consistent manner, thus reducing inconsistencies in colorization of video content or other sequences of images that may arise in colorization performed using other techniques.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 illustrates a computer system configured to implement one or more aspects of various embodiments of the present invention.

FIG. 2 illustrates a pipeline for training a generative artificial intelligence model to colorize visual content, according to some embodiments.

FIG. 3 is a flow diagram of operations for training a generative artificial intelligence model to colorize visual content, according to some embodiments.

FIG. 4 illustrates an example pipeline for colorizing input visual content using a generative artificial intelligence model, according to some embodiments.

FIG. 5 illustrates an example pipeline for colorizing input visual content using a generative artificial intelligence model and color guidance included in an input prompt, according to some embodiments.

FIG. 6 is a flow diagram of operations for colorizing visual content using a generative artificial intelligence model, according to some embodiments.

### DETAILED DESCRIPTION

In the following description, numerous specific details are set forth to provide a more thorough understanding of the various embodiments. However, it will be apparent to one skilled in the art that the inventive concepts may be practiced without one or more of these specific details.

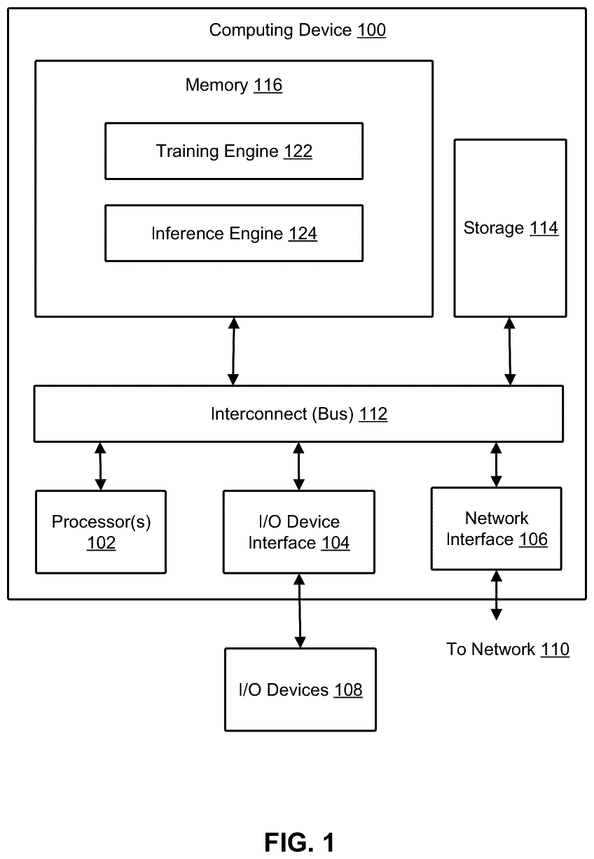

FIG. 1 illustrates a computing device 100 configured to implement one or more aspects of various embodiments of the present invention. In one embodiment, computing device 100 includes a desktop computer, a laptop computer, a smart phone, a personal digital assistant (PDA), tablet computer, or any other type of computing device configured to receive input, process data, and optionally display images, and is suitable for practicing one or more embodiments. Computing device 100 is configured to run a training engine 122 and an inference engine 124 that reside in a memory 116.

It is noted that the computing device described herein is illustrative and that any other technically feasible configurations fall within the scope of the present disclosure. For example, multiple instances of training engine 122 or inference engine 124 could execute on a set of nodes in a distributed and/or cloud computing system to implement the functionality of computing device 100. In another example, training engine 122 or inference engine 124 could execute on various sets of hardware, types of devices, or environments to adapt training engine 122 or inference engine 124 to different use cases or applications. In a third example, training engine 122 or inference engine 124 could execute on different computing devices and/or different sets of computing devices.

In one embodiment, computing device 100 includes, without limitation, an interconnect (bus) 112 that connects one or more processors 102, an input/output (I/O) device interface 104 coupled to one or more input/output (I/O) devices 108, memory 116, a storage 114, and a network interface 106. Processor(s) 102 may be any suitable processor implemented as a central processing unit (CPU), a graphics processing unit (GPU), an application-specific integrated circuit (ASIC), a field programmable gate array (FPGA), an artificial intelligence (AI) accelerator, any other type of processing unit, or a combination of different processing units, such as a CPU configured to operate in conjunction with a GPU. In general, processor(s) 102 may be any technically feasible hardware unit capable of processing data and/or executing software applications. Further, in the context of this disclosure, the computing elements shown in computing device 100 may correspond to a physical computing system (e.g., a system in a data center) or may be a virtual computing instance executing within a computing cloud.

I/O devices 108 include devices capable of providing input, such as a keyboard, a mouse, a touch-sensitive screen, a microphone, and so forth, as well as devices capable of providing output, such as a display device or speaker. Additionally, I/O devices 108 may include devices capable of both receiving input and providing output, such as a touchscreen, a universal serial bus (USB) port, and so forth. I/O devices 108 may be configured to receive various types of input from an end-user (e.g., a designer) of computing device 100, and to also provide various types of output to the end-user of computing device 100, such as displayed digital images or digital videos or text. In some embodiments, one or more of I/O devices 108 are configured to couple computing device 100 to a network 110.

Network 110 is any technically feasible type of communications network that allows data to be exchanged between computing device 100 and external entities or devices, such as a web server or another networked computing device. For example, network 110 may include a wide area network (WAN), a local area network (LAN), a wireless (Wi-Fi) network, and/or the Internet, among others.

Storage 114 includes non-volatile storage for applications and data, and may include fixed or removable disk drives, flash memory devices, and CD-ROM, DVD-ROM, Blu-Ray, HD-DVD, or other magnetic, optical, or solid-state storage devices.

Training engine 122 and inference engine 124 may be stored in storage 114 and loaded into memory 116 when executed.

Memory 116 includes a random-access memory (RAM) module, a flash memory unit, or any other type of memory unit or combination thereof. Processor(s) 102, I/O device interface 104, and network interface 106 are configured to read data from and write data to memory 116. Memory 116 includes various software programs that can be executed by processor(s) 102 and application data associated with said software programs, including training engine 122 or inference engine 124.

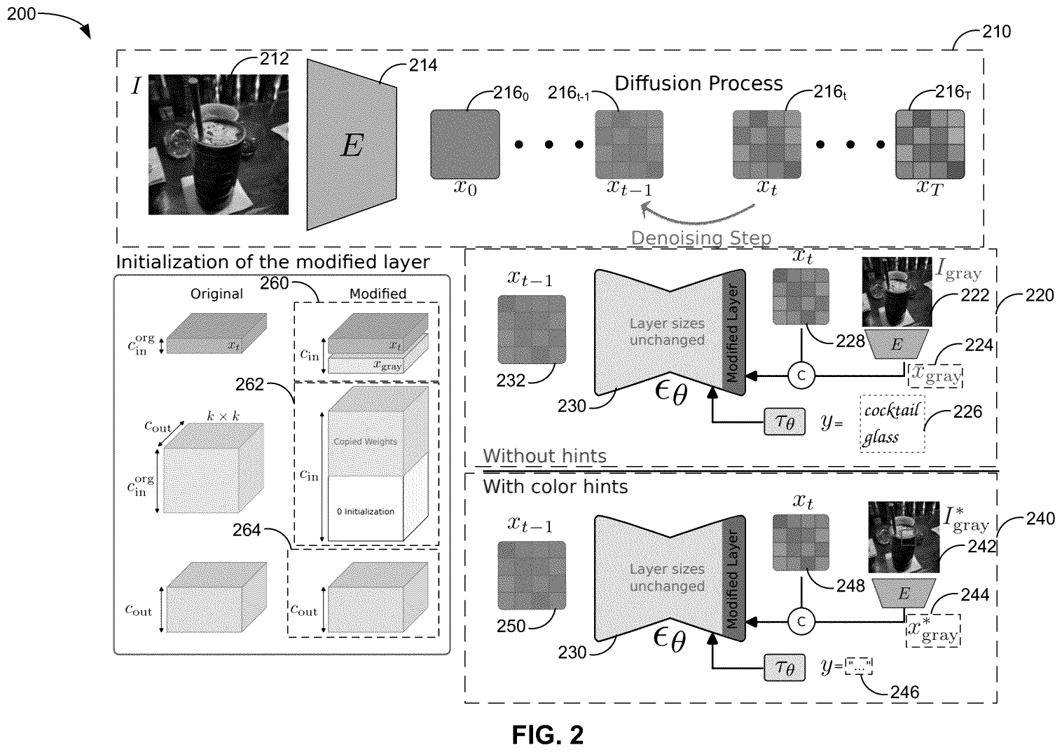

FIG. 2 illustrates a training pipeline 200 for training a generative artificial intelligence model to colorize visual content, according to some embodiments. The training pipeline 200 may execute, for example, on the training engine 122 to train one or more machine learning models to colorize an input image based on an input prompt specifying a coloration to apply to the image or portions thereof.

To train a generative model to colorize visual content, embodiments of the present disclosure may adapt a pre-trained generative model 210 to colorize an image. Generally, the pre-trained generative model 210 may be a foundation model that is trained to generate output images based on an input prompt specifying the content of an image and progressive denoising of a noise map. To train the pre-trained generative model 210, an image I 212 may be encoded into an encoding 216₀ of the image I 212 in a latent space via an encoder E 214. The encoder E 214 may, in some embodiments, be a variational autoencoder or other encoder trained to encode an image or other visual content into a latent space. Additional amounts of noise may be added in each noise addition round 1 through T until random noise encoding x_{T} 216_{T} is generated. During inferencing, the generative model 210 may be trained to recover the image I 212 (or at least generate an approximation of the image I 212) by progressively denoising random noise x_{T} 216_{T} (e.g., via progressively denoised encodings 216ₜ, 216ₜ₋₁, and so on) until the encoding 216₀ is generated by the generative model 210.

Generally, adaptation of the generative model 210 may be performed by training or adapting the generative model 210 to learn the conditional distribution of color images I, p(I|I_{grey}), given a grayscale image I_{grey}. To do so, images I and I_{grey} may be encoded by the encoder E 214, and noise may be added to the encodings of the images I during the forward process at each time step t E {0, . . . , T} according to the equation:

$${x}_{t} = \sqrt{γ} {x}_{0} + \sqrt{1 - {γ}_{ϵ}}$$

where ϵ˜N(0, I) and the parameterization of γ controls the variance schedule of the process of adding noise to an encoding of an image I until noise encoding x_{T} 216_{T} is generated.

In the reverse, to generate an image I from random noise, a denoising network may be trained with parameters that minimizes a loss defined by the equation:

$$ℒ = {𝔼}_{x , y , t , ϵ} {‖ ϵ - {ϵ}_{θ} ( {x}_{t} , {τ}_{θ} ( y ) , t , {x}_{grey} ‖}_{2}^{2}$$

where x=E(I) and I are sampled from an image data set with corresponding text prompts y and t is uniformly sampled in a set of diffusion steps. τ_{θ} generally represents a part of the generative model 210 that transforms textual prompts into an input in one or more layers of the generative model 210 to an input specifying the output of the generative model 210.

In adapting the generative model 210 to generate a colorized image from an input image, one or more layers of the generative model 210 may be modified to accept an input 260 of an encoding of a color image xₜ and an encoding of a corresponding grayscale image x_{grey}. In some embodiments, the one or more layers of the generative model 210 that is modified to accept the input 260 may be an initial convolutional layer of the generative model 210. The weight matrix 262 of the modified layer in the generative model 210 may include the weights copied from the un-modified layer in the generative model 210 and a set of weights initialized to 0, such that the weight matrix 262, like the input 260, is increased in size relative to the weight matrix from the un-modified layer in the generative model 210. The output 264 of the modified layer may be generated based on the input 260 and the weight matrix 262 (e.g., by multiplying the input 260 and weight matrix 262) and may have the same size as the output of the un-modified layer in the generative model 210.

The generative model 210 may be adapted to generate a colorized image based on a textual prompt or color hints included in or otherwise associated with an input grayscale image. In the example 220, the generative artificial intelligence model 210 is adapted to generate a colorized image from an input grayscale image 222 and a text prompt 226. As illustrated, to adapt the generative artificial intelligence model to generate a colorized image from an input grayscale image 222 and a text prompt 226, the input grayscale image 222 may be encoded into an embedding x_{gray} and concatenated with a noise map 228 for denoising. The denoising generative model εe 230 may take the concatenation of the encoding 224 of the grayscale image 222 and the noise map 228 and a representation τ_{θ} of the text prompt 226 as an input. The concatenation of the encoding 224 of the grayscale image 222 and the noise map 228, corresponding to the input 260 discussed above, may be processed based on the weight matrix 262 to generate an output 264 of the modified layer of the denoising generative model ϵθ 230. The output 264 of processing the concatenation of the encoding 224 of the grayscale image 222 and the noise map 228 in the initial layer of the denoising generative model ϵ_{θ} 230 may be processed via subsequent layers of the denoising generative model ϵ_{θ} 230 to generate a denoised version 232 of the noise map 228 and to iteratively learn weights to be used in determining a colorization to apply to input visual content.

In some embodiments, while not illustrated in FIG. 2, the denoising generative model ϵ_{θ} 230 may be further trained to colorize images based on additional color words that can be included in the input prompt 226 accompanying a grayscale image 222. The denoising generative model ϵ_{θ} 230 can use cross-attention maps associated with different specified objects in the input prompt 226 accompanying a grayscale image 222 to learn boundaries for applying colorization to objects and minimize, or at least reduce, the likelihood of the denoising generative model ϵ_{θ} 230 leaking color from one object to another.

In the example 240, the generative artificial intelligence model 210 is adapted to generate a colorized image from an input grayscale image 242 including one or more color hints. The color hints may include, for example, colorized patches in the input grayscale image 242 (as illustrated in FIG. 2), textual hints included in a textual prompt 246, or the like. When colorized patches in the input grayscale image 242 are included as color hints for the denoising generative model ϵ_{θ} 230, the textual prompt 246 may be a blank prompt, a null string, or the like, so that the denoising generative model ϵ_{θ} performs inferencing without the color hints provided in the input grayscale image 242. As with the example 220, to train the denoising generative model 230, the grayscale image 242 may be encoded into an embedding x_{gray} and concatenated with a noise map 248. The text prompt 246, meanwhile, may be converted into a representation τ_{θ}. The concatenation of the encoding 244 of the grayscale image 242 and the noise map 248, corresponding to the input 260 discussed above, may be processed based on the weight matrix 262 to generate an output 264 of the modified layer of the denoising generative model ϵ_{θ} 230. The output 264 of processing the concatenation of the encoding 244 of the grayscale image 242 and the noise map 248 in the initial layer of the denoising generative model ϵ_{θ}, 230 may be processed via subsequent layers of the denoising generative model ϵ_{θ} 230 to generate a denoised version 250 of the noise map 248 and to iteratively learn weights to be used in determining a colorization to apply to input visual content.

The denoising generative model ϵ_{θ} 230 may be trained to colorize visual content based on color hints by learning to propagate the color hints in a meaningful manner. To do so, the denoising generative model ϵ, 230 can use semantic segmentation techniques to segment the grayscale image 242 into a plurality of segments associated with different content in the grayscale image 242 (e.g., different instances of objects, different objects, background content, etc.). Within each semantic region, point matches may be computed against the grayscale image 242 to identify the objects associated with different color hints, and the information about the identified object associated with a color hint may be used as conditioning data for training the denoising generative model ϵ, 230.

In learning to generate a colorized version of an input grayscale image, the denoising generative model 230 can learn to generate an encoded version of a colorized image that can be decoded using a D from the pre-trained variational autoencoder from which the encoder E 214 is sourced. As discussed in further detail herein, hue and chrominance information can be extracted from the output of the decoder D and combined with luminance information from the input grayscale image to generate the colorized image. By doing so, embodiments presented herein may allow for visual content to be colorized while retaining detail from luminance data in the source image to which colorization is generated and applied. Generally, by training the denoising generative model ϵ, 230 using pairs of colorized images and grayscale images, the denoising generative model ϵ_{θ} 230 can learn to generate diverse colorizations of images. Generally, different colorization results may be obtained from the denoising generative model ϵ_{θ} 230 by sampling different latents x_{T}, which may correspond to different plausible colorizations generated by the denoising generative model ϵ_{θ} 230.

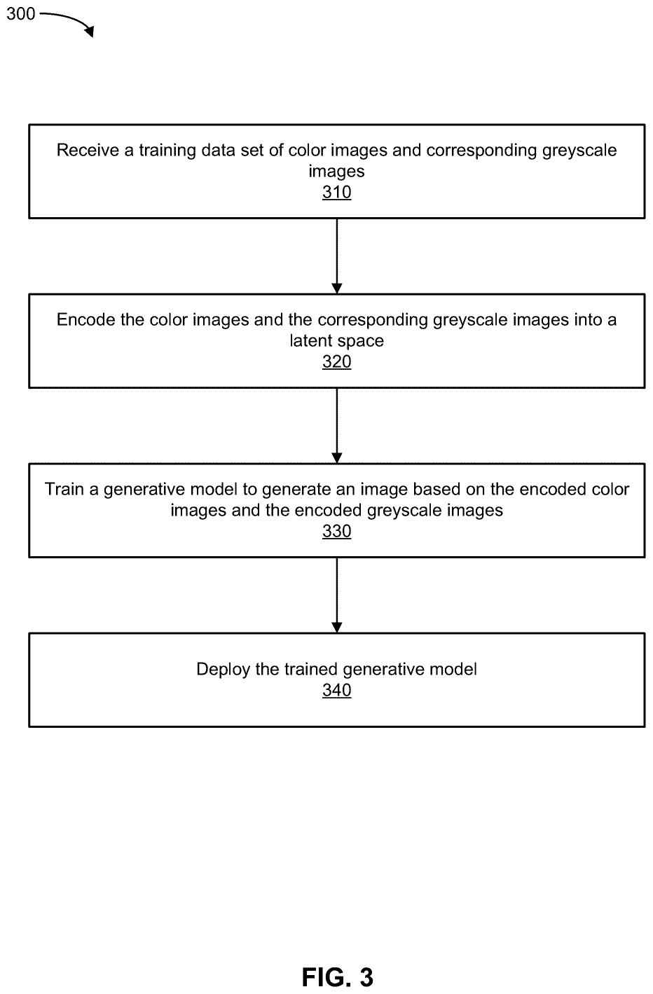

FIG. 3 is a flow diagram of operations 300 for training a generative artificial intelligence model to colorize visual content, according to some embodiments. The operations 300 may be performed, for example, by a computing device including one or more processors on which a training engine 122 illustrated in FIG. 1 can execute, such as a desktop computer, a server, a cluster of computing devices, one or more cloud compute instances, or the like.

As illustrated, operations 300 begin at block 310, in which a processor receives a training data set of color images and corresponding grayscale images. The color images may be colored using additive color spaces, such as sRGB, Adobe RGB, ProPhoto RGB, Rec. 709, Rec. 2020, DCI-P3, L*a*b* color spaces, or the like; subtractive color spaces, such as various CMYK color spaces; or other spaces in which color data may be defined.

At block 320, the operations 300 proceed with encoding the color images and the corresponding grayscale images into a latent space.

At block 330, the operations 300 proceed with training a generative model to generate an image based on the encoded color images and the encoded grayscale images.

At block 340, the operations 300 proceed with deploying the trained generative model.

In some embodiments, a convolutional layer of the generative model has an input size set based on a size of a color image and a size of a corresponding grayscale image in the training data set. The convolutional layer of the generative model may be modified from a corresponding layer of a foundation generative model to accommodate the increased size of an input into the convolutional layer. For example, where the foundation generative model takes as input an encoded version of an image with size org, the generative model takes as input a concatenation of the encoded version of the image and an encoded version of a grayscale version of the image having a size cᵢₙ.

In some embodiments, weights associated with a convolutional layer in the generative model comprise a first set of weights copied from a pretrained version of the generative model and a second set of weights initialized to 0. Expanding the weights associated with the convolutional model from the first set of weights to the combination of the first and second sets of weights may allow for an input having a size cᵢₙ to be processed into an output having a size cₒᵤₜ that matches the size of the output of the corresponding convolutional layer in the foundation generative model.

In some embodiments, the generative model is trained to generate a color map to apply to a grayscale image in a hue and chrominance color space.

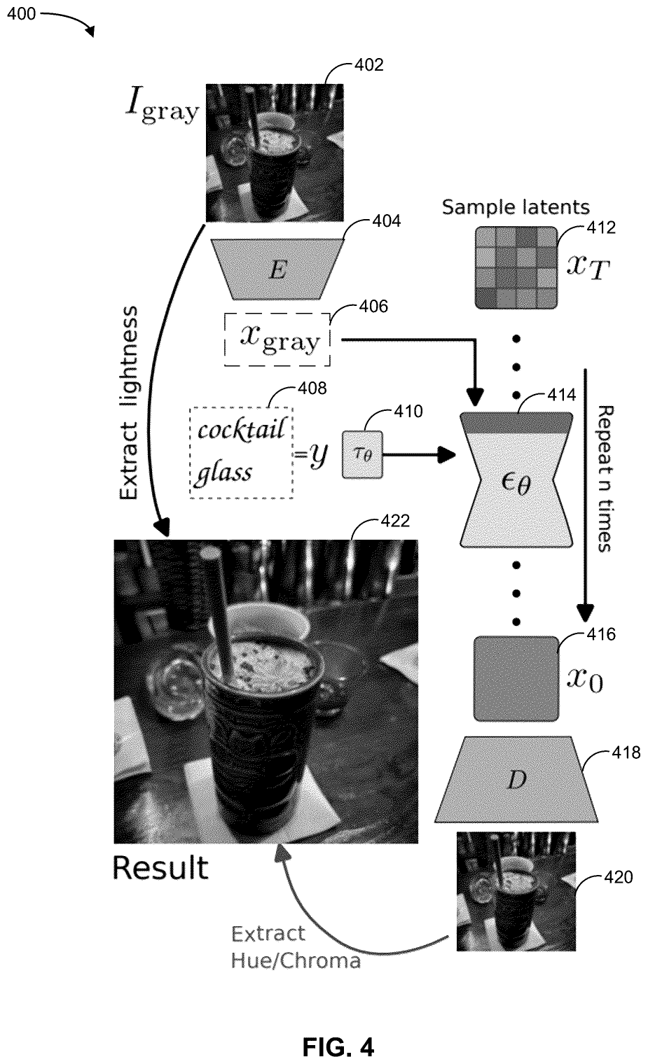

FIG. 4 illustrates an example pipeline 400 for colorizing input visual content using a generative artificial intelligence model, according to some embodiments.

To colorize an image, a grayscale image 402 and a text prompt 408 may be input into a generative model. The generative model may include an encoder 404, a denoising generative model 414 (corresponding to the denoising generative model 230 discussed above with respect to FIG. 2), and a decoder 418. The grayscale image 402 may be input into the encoder 404 to generate an encoded grayscale image x_{gray} 406. Meanwhile, the text prompt 408 may be processed into another representation via a transformation block τ_{θ} 410. Finally, random noise x_{T} 412 may be input into the denoising generative model 414 for processing.

Over n iterations, the random noise x_{T} 412 may be denoised based on the encoded grayscale image x_{gray} 406 and the representation of the text prompt 408 until an output encoding x₀ 416 of a colorized version of the grayscale image 402 is generated. Generally, during inferencing, the denoising generative model can use classifier-free guidance to iteratively generate denoised outputs ϵ according to the equation:

$$\overline{ϵ} = ( 1 + w ) {ϵ}_{θ} ( {x}_{t} , t , y , {x}_{gray} ) - wϵ\_θ ( {x}_{t} , t , {x}_{gray} )$$

In the equation above, w corresponds to the weights of the denoising generative model 414, t corresponds to the time step in which the denoised output ϵ is generated, y represents the text prompt 408, xₜ represents the image being denoised at time step t, and x_{gray} represents the encoded version of the grayscale image 402 to be colorized.

The output encoding x, 416 of the denoising generative model 414 may be input into a decoder D to generate a colorized image 420. Because the colorized image 420 may not preserve detail from the grayscale image 402, hue and chrominance information may be extracted from the colorized image 420. To generate an output image that preserves the generated color from the colorized image 420 and detail from the grayscale image 402, luminance data extracted from the grayscale image 402 may be combined with hue and chrominance data extracted from the colorized image 420 to generate an output colorized image 422.

The denoising generative model 414 generally allows for the output of a variety of colorization results. To do so, different latents x_{T} may be sampled by the denoising generative model 414. The ability of the denoising generative model 414 to generate content with different hue and chrominance data may allow for the output of diverse colorization results for an image that corresponds to plausible colorations that can exist for a given grayscale image 402.

In some embodiments, various techniques may be used to condition how the denoising generative model 414 colorizes an image. Generally, color hints may be provided directly from colorizing points in a grayscale image or may be derived from an input, and the denoising generative model 414 can use these color hints to generate a colorized image using classifier-free guidance, according to the equation:

$$\overline{ϵ} = ( 1 + w ) {ϵ}_{θ} ( {x}_{t} , t , y , {x}_{gray}^{*} ) - w {ϵ}_{θ} ( {x}_{t} , t , {x}_{gray}^{*} )$$

where x*_{gray} corresponds to a grayscale image 402 including one or more color hints explicitly specified in the image or derived from another input into the denoising generative model 414.

For example, as discussed with respect to FIG. 2 above, the grayscale image 402 may be accompanied by one or more color hints. These color hints may be color patches added to various points in the grayscale image 402. During the denoising process, the color hints can be used in conjunction with semantic segmentation or other objection detection techniques to localize the colorization applied to different objects in the grayscale image 402. In some embodiments, the color hints may be extracted from a reference image. To do so, a semantic segmentation model or other object detection model can be used to identify objects in a reference image from which color hints are to be extracted and objects in the grayscale image 402. Color data extracted from an object in the reference image may be used to identify a point in the grayscale image 402 at which a color hint is to be applied prior to inputting the grayscale image 402 and color hints into the denoising generative model 414. Generally, a point in the grayscale image 402 at which a color hint is to be applied may be a point inside a bounding area associated with the same type of object as the object in the reference image from which a color hint is extracted. For example, to colorize an image of a bird, color hints associated with plumage in the reference image may be applied to plumage in the grayscale image, color hints associated with a bird's beak in the reference image may be applied to a bird's beak in the grayscale image, and so on. In another example, a natural language or other textual prompt may specify colorization to apply to different objects in an image. A natural language processing model may be trained to identify color and object words from the natural language prompt. Using the object words extracted from a natural language processing model, a semantic segmentation or object detection model can be used to identify corresponding objects in the grayscale image 402. At a point inside a bounding area associated with an object, a corresponding color hint extracted from the natural language prompt may be inserted.

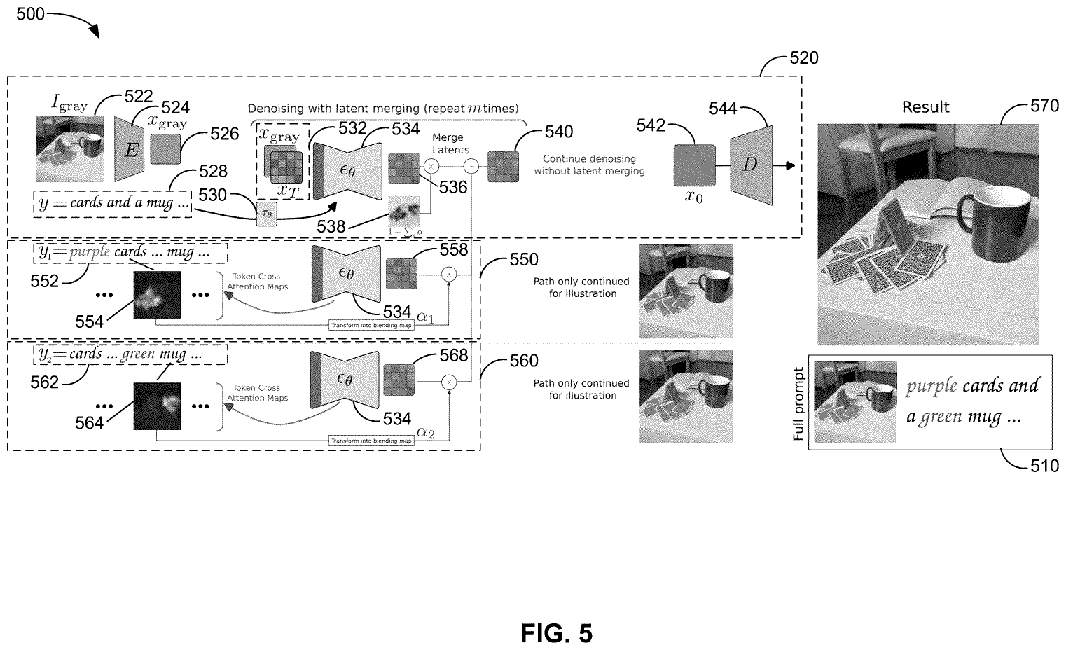

FIG. 5 illustrates an example pipeline 500 for colorizing input visual content using a generative artificial intelligence model and color guidance included in an input prompt 510, according to some embodiments. While the color guidance included in the input prompts illustrated in FIG. 5 are illustrated as textual color guidance, it should be recognized that the color guidance may be any of a variety of inputs, such as color hints overlaid on or otherwise associated with different regions of a grayscale image, color in a reference image used to colorize a grayscale image, or the like.

Generally, to colorize input visual content based on color guidance in an input prompt, a grayscale image may be colorized using a plurality of colorization operations executed in parallel. A primary denoising process 520 may be executed using textual sub-prompt y 528, which specifies the objects in a grayscale image I_{gray} 522, while one or more secondary denoising processes 550, 560 (amongst others not illustrated in FIG. 5) may be executed for specific objects to be colorized in the grayscale image I_{gray} 522. For example, as illustrated, the secondary denoising process 550 may be used to apply a specific coloration (e.g., purple) to a specific object (e.g., cards), and the secondary denoising process 560 may be used to apply another coloration (e.g., green) to another object (e.g., a mug) depicted in the grayscale image I_{gray} 522. Generally, the primary denoising process 520 may have color prompts removed to minimize, or at least reduce, color leakage from colorizing the grayscale image I_{gray} 522.

In the primary denoising process 520, the grayscale image I_{gray} 522 may be input into the encoder 524, and the encoder 524 may generate the encoded grayscale image x_{gray} 526 for use as an input into the denoising generative model 534. The denoising generative model 534 may receive a representation of the textual sub-prompt 528 generated by the transformation block 530 and a combined input 532 of the encoded grayscale image x_{gray} 526 and a sampled latent x, and may denoise the latent x_{T} by executing multiple inferencing (denoising) rounds.

In parallel, the secondary denoising processes 550, 560 (amongst others) may generate respective attention maps 554, 564 corresponding to the objects associated with a color hint in the respective textual sub-prompts 552, 562. The attention maps 554, 564 may be input, along with the encoded grayscale image x_{gray} 526, into the denoising generative model 534. Any number of denoising iterations may be performed in the secondary denoising processes 550, 560 to generate a noise map and attention map. The attention maps 554, 564 may be transformed into blending maps that are added to the denoised latents 558, 568 to generate masked latents associated with the objects to be colorized in each of the secondary denoising processes 550, 560. Subsequently, a latent 536, masked by an attention mask 538 associated with the objects specified in the textual sub-prompt y 528, may be merged with the masked latents generated by the secondary denoised processes 550, 560 to generate a merged latent 540. Generally, the number m of denoising iterations performed prior to generating the merged latent 540 may be defined based on a total number of denoising iterations performed to generate a colorized image from the grayscale image I_{gray} 522; for example, the number m of denoising iterations may be set to between 50% and 80% of the total number of denoising iterations to be performed (though it should be recognized that these numbers are but examples, and any number of denoising iterations prior to generating the merged latent 540 may be executed).

The merged latent 540 may be subsequently denoised by the primary denoising process 520 until a denoised latent x₀ 542 is generated. The denoised latent x₀ 542 may be decoded by a decoder D 544 to generate a color source image from which hue and chrominance information is extracted. The hue and chrominance information extracted from the color source image may be combined with luminance information from the grayscale image I_{gray} 522 to generate the output colorized image 570. The output colorized image 570 may generally reflect the colorization specified in the input prompt 510.

Generally, the denoising pipeline 400 illustrated in FIG. 4 and/or the denoising pipeline 500 illustrated in FIG. 5 may be used to colorize individual grayscale images or visual content with a temporal component (e.g., video content). To preserve the consistency of colorations applied to objects in visual content with a temporal component, cross-frame color propagation may be used. In colorizing frames of visual content with a temporal component using cross-frame color propagation, self-attention operations in the denoising generative model 414, 534 may be repurposed for cross-frame attention. A keyframe k may be colorized by the denoising generative model 414, 534. For a subsequent frame i, cross-frame attention may be calculated according to the equation:

$$CFAttention ( {Q}^{i} , {K}^{k} , {V}^{k} ) = Soft max ( \frac{{{Q}^{i} ( {K}^{k} )}^{T}}{\sqrt{c}} ) {V}^{k}$$

In the equation above, Qⁱ corresponds to queries from the frame i, K^{k} and V^{k} correspond to keys and values from the keyframe k, and c corresponds to a size of the output of an attention layer in the denoising generative model. Hue and chrominance data may be considered as the predicted quantities of the denoising generative model, which may allow for temporal stability across frames in video content or other visual content with a temporal component. Generally, as the length of video content or visual content with a temporal component increases, the number of keyframes may also increase so that colorization applied to a video remains temporally stable and so that conditioning signals used to define the colorization applied to different frames in the video are not too distant temporally from a keyframe k to an frame i.

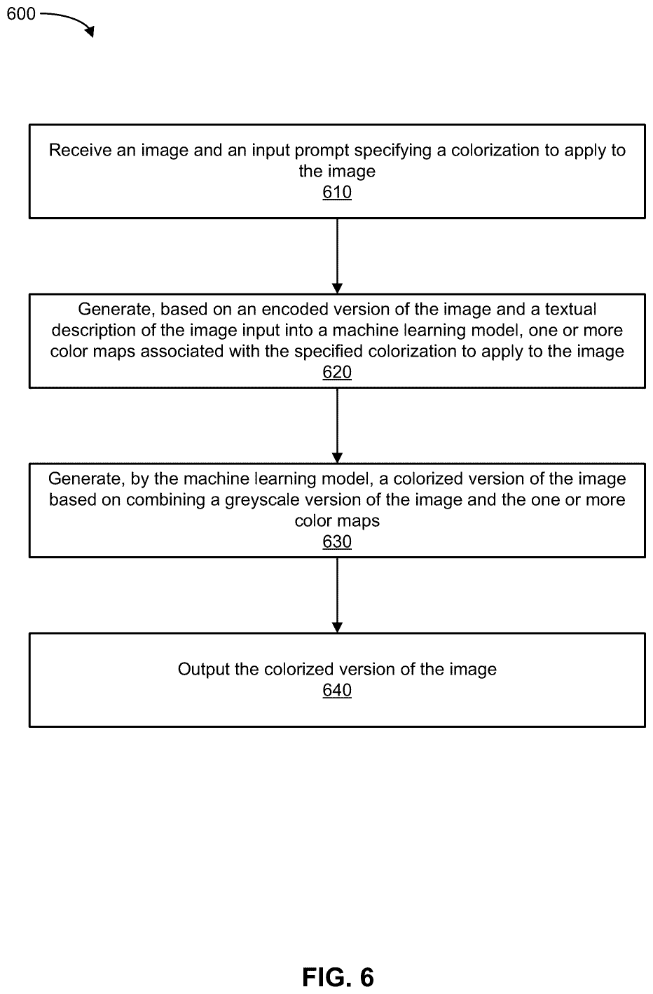

FIG. 6 is a flow diagram of operations 600 for colorizing visual content using a generative artificial intelligence model, according to some embodiments. Operations 600 may be performed for example, by a computing device including one or more processors on which an inference engine 124 illustrated in FIG. 1 can execute, such as a laptop computer, a desktop computer, a server, a smartphone, a table computer, a cluster of computing devices, one or more cloud compute instances, or the like.

As illustrated, operations 600 may begin at block 610 with a processor receiving an image and an input prompt specifying a colorization to apply to the image.

In some embodiments, the input prompt specifying the colorization to apply to the image comprises a textual prompt specifying a color associated with one or more objects in the image. The textual prompt may, in some embodiments, be used to generate multiple textual sub-prompts for processing using the generative model. A first textual sub-prompt may remove colorization words from the input prompt and may be processed by a primary denoising process. One or more second textual sub-prompts may include colorization words associated with specific objects, and each of these second textual sub-prompts may be processed by a respective secondary denoising process.

In some embodiments, the input prompt specifying the colorization to apply to the image comprises an image including one or more color hints, each respective hint of the one or more color hints identifying a color associated with a respective object in the image. To use the color hints, various object detection or semantic segmentation models can be used to identify an object associated with a specific color hint, and the association of an object with a specific color hint can be used during a denoising process to colorize the image.

In some embodiments, the input prompt specifying the colorization to apply to the image may include a colorized reference image. Colors associated with objects in the reference image may be extracted from the colorized reference image, and one or more prompts may be generated to specify a colorization to apply to different objects in the received image.

At block 620, the operations 600 proceed with generating, based on an encoded version of the image and a textual description of the image input into a machine learning model, one or more color maps associated with the specified colorization to apply to the image.

In some embodiments, the encoded version of the image comprises an encoded version of the greyscale version of the image.

In some embodiments, generating the one or more color maps may include decomposing the input prompt into a plurality of sub-prompts comprising textual prompts associated with individual objects from the one or more objects, and wherein the machine learning model is configured to process the plurality of sub-prompts substantially in parallel.

At block 630, the operations 600 proceed with generating, by the machine learning model, a colorized version of the image based on combining a greyscale version of the image and the one or more color maps.

In some embodiments, the one or more color maps associated with the specified colorization to apply to the image comprise one or more masks, each respective mask of the one or more masks being associated with a respective object in the image.

In some embodiments, to generate the colorized version of the image, luminance information from the greyscale version of the image may be combined with hue and chrominance information from the one or more color maps.

In some embodiments, to generate the colorized version of the image, a combined latent representation may be generated by one or more first denoising layers of the machine learning model. The combined latent representation may include a combination of a latent representation of the grayscale version of the image and latent representations of the one or more color maps. The combined latent representation may be processed through one or more second denoising layers of the machine learning model. A colorized version of the image may be decoded based on an output of processing the combined latent representation through the one or more second denoising layers of the machine learning model. In some embodiments, the combined latent representation may be generated by denoising a latent representation of the grayscale version of the image in a first denoising process and denoising latent representations of one or more latent representations of portions of the image to which specific colorations are to be applied in one or more second denoising processes. The first denoising process and the one or more second denoising processes may execute in parallel and may execute m denoising rounds of T total denoising rounds used to generate the colorized version of the image, where m<T.

At block 640 the operations 600 proceed with outputting the colorized version of the image.

In some embodiments, the colorized version of the image comprises a colorized version of a keyframe in video content. To colorize one or more frames subsequent to the keyframe (e.g., to colorize one or more frames i), the frames may be colorized based on colorization applied to one or more objects in the keyframe such that colorization of the one or more objects is consistent across the colorized version of the keyframe and colorized versions of the one or more frames subsequent to the keyframe. As discussed, consistency of colorization across a keyframe and one or more frames may be achieved by using cross-frame attention so that the colorization applied to an object in a keyframe is maintained for that same object in a subsequent frame.

In some embodiments, the machine learning model comprises a diffusion model including one or more layers configured to generate the one or more color maps based on an input image and a greyscale version of the input image.

The techniques discussed herein generally allow generative models to generate diverse colorizations for grayscale images and to do so in a temporally consistent manner for visual content including a temporal component. For single-frame colorization, embodiments presented herein may generate colorized images with an increased range of colors relative to prior approaches and may allow for color hints associated with specific objects in an image to be accurately propagated to those specific objects while minimizing, or at least reducing, color leakage to other objects in an image. For video content colorization, embodiments presented herein may reduce the amount of color artifacting (e.g., bleeding, leakage, etc.) and increase temporal consistency of colorization across frames relative to prior approaches. These technical advantages provide one or more improvements over prior approaches.

### Example Clauses

Various embodiments of the present disclosure are described in the following numbered clauses:

1. In some embodiments, a computer-implemented method for colorizing visual content using generative models, the computer-implemented method comprises receiving an image and an input prompt specifying a colorization to apply to the image; generating, based on an encoded version of the image and a textual description of the image input into a machine learning model, one or more color maps associated with the specified colorization to apply to the image; generating, by the machine learning model, a colorized version of the image based on combining a greyscale version of the image and the one or more color maps; and outputting the colorized version of the image.

2. The method of clause 1, wherein the one or more color maps associated with the specified colorization to apply to the image comprise one or more masks, each respective mask of the one or more masks being associated with a respective object in the image.

3. The method of clauses 1 or 2, wherein generating the colorized version of the image comprises combining luminance information from the greyscale version of the image and hue and chrominance information from the one or more color maps.

4. The method of any of clauses 1 through 3, wherein the colorized version of the image comprises a colorized version of a keyframe in video content.

5. The method of clause 4, further comprising generating colorized versions of one or more frames subsequent to the keyframe based on colorization applied to one or more objects in the keyframe such that colorization of the one or more objects is consistent across the colorized version of the keyframe and colorized versions of the one or more frames subsequent to the keyframe.

6. The method of any of clauses 1 through 5, wherein the machine learning model comprises a diffusion model including one or more layers configured to generate the one or more color maps based on an input image and a greyscale version of the input image.

7. The method of any of clauses 1 through 6, wherein generating the colorized version of the image comprises: generating, by one or more first denoising layers of the machine learning model, a combined latent representation based on combining a latent representation of the greyscale version of the image and latent representations of the one or more color maps; processing the combined latent representation through one or more second denoising layers of the machine learning model; and decoding the colorized version of the image based on an output of processing the combined latent representation through the one or more second denoising layers of the machine learning model.

8. The method of any of clauses 1 through 7, wherein the encoded version of the image comprises an encoded version of the greyscale version of the image.

9. The method of any of clauses 1 through 8, wherein the input prompt specifying the colorization to apply to the image comprises a textual prompt specifying a color associated with one or more objects in the image.

10. The method of clause 9, wherein generating the one or more color maps comprises decomposing the input prompt into a plurality of sub-prompts comprising textual prompts associated with individual objects from the one or more objects, and wherein the machine learning model is configured to process the plurality of sub-prompts substantially in parallel.

11. The method of any of clauses 1 through 10, wherein the input prompt specifying the colorization to apply to the image comprises an image including one or more color hints, each respective hint of the one or more color hints identifying a color associated with a respective object in the image.

12. In some embodiments, a processor-implemented method for training generative models to colorize visual content, the computer-implemented method comprises, receiving a training data set of color images and corresponding greyscale images; encoding the color images and the corresponding greyscale images into a latent space; training a generative model to generate an image based on the encoded color images and the encoded greyscale images; and deploying the trained generative model.

13. The method of clause 12, wherein a convolutional layer of the generative model has an input size set based on a size of a color image and a size of a corresponding greyscale image in the training data set.

14. The method of clauses 12 or 13, wherein weights associated with a convolutional layer in the generative model comprise a first set of weights copied from a pretrained version of the generative model and a second set of weights initialized to 0.

15. The method of clause 14, wherein a size of an output of the convolutional layer in the generative model is equal to a size of an output of a corresponding convolutional layer in the pretrained version of the generative model.

16. The method of any of clauses 12 through 15, wherein the generative model is trained to generate a color map to apply to a greyscale image in a hue and chrominance color space.

17. A processing system, comprising: at least one memory having executable instructions thereon; and one or more processors configured to execute the executable instructions to cause the processing system to perform the method of any of clauses 1 through 16.

18. A non-transitory computer-readable medium having executable instructions stored thereon which, when processed by one or more processors, causes the one or more processors to perform the method of any of clauses 1 through 16.

Any and all combinations of any of the claim elements recited in any of the claims and/or any elements described in this application, in any fashion, fall within the contemplated scope of the present invention and protection.

The descriptions of the various embodiments have been presented for purposes of illustration but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A processor-implemented method, comprising:
receiving an image and an input prompt specifying a colorization to apply to the image;
generating, based on an encoded version of the image and a textual description of the image input into a machine learning model, one or more color maps associated with the specified colorization to apply to the image;
generating, by the machine learning model, a colorized version of the image based on combining a greyscale version of the image and the one or more color maps; and
outputting the colorized version of the image.

2. The method of claim 1, wherein the one or more color maps associated with the specified colorization to apply to the image comprise one or more masks, each respective mask of the one or more masks being associated with a respective object in the image.

3. The method of claim 1, wherein generating the colorized version of the image comprises combining luminance information from the greyscale version of the image and hue and chrominance information from the one or more color maps.

4. The method of claim 1, wherein the colorized version of the image comprises a colorized version of a keyframe in video content.

5. The method of claim 4, further comprising generating colorized versions of one or more frames subsequent to the keyframe based on colorization applied to one or more objects in the keyframe such that colorization of the one or more objects is consistent across the colorized version of the keyframe and colorized versions of the one or more frames subsequent to the keyframe.

6. The method of claim 1, wherein the machine learning model comprises a diffusion model including one or more layers configured to generate the one or more color maps based on an input image and a greyscale version of the input image.

7. The method of claim 1, wherein generating the colorized version of the image comprises:
generating, by one or more first denoising layers of the machine learning model, a combined latent representation based on combining a latent representation of the greyscale version of the image and latent representations of the one or more color maps;
processing the combined latent representation through one or more second denoising layers of the machine learning model; and
decoding the colorized version of the image based on an output of processing the combined latent representation through the one or more second denoising layers of the machine learning model.

8. The method of claim 1, wherein the encoded version of the image comprises an encoded version of the greyscale version of the image.

9. The method of claim 1, wherein the input prompt specifying the colorization to apply to the image comprises a textual prompt specifying a color associated with one or more objects in the image.

10. The method of claim 9, wherein generating the one or more color maps comprises decomposing the input prompt into a plurality of sub-prompts comprising textual prompts associated with individual objects from the one or more objects, and wherein the machine learning model is configured to process the plurality of sub-prompts substantially in parallel.

11. The method of claim 1, wherein the input prompt specifying the colorization to apply to the image comprises an image including one or more color hints, each respective hint of the one or more color hints identifying a color associated with a respective object in the image.

12. A processor-implemented method, comprising:
receiving a training data set of color images and corresponding greyscale images;
encoding the color images and the corresponding greyscale images into a latent space;
training a generative model to generate an image based on the encoded color images and the encoded greyscale images; and
deploying the trained generative model.

13. The method of claim 12, wherein a convolutional layer of the generative model has an input size set based on a size of a color image and a size of a corresponding greyscale image in the training data set.

14. The method of claim 12, wherein weights associated with a convolutional layer in the generative model comprise a first set of weights copied from a pretrained version of the generative model and a second set of weights initialized to 0.

15. The method of claim 14, wherein a size of an output of the convolutional layer in the generative model is equal to a size of an output of a corresponding convolutional layer in the pretrained version of the generative model.

16. The method of claim 12, wherein the generative model is trained to generate a color map to apply to a greyscale image in a hue and chrominance color space.

17. A processing system, comprising:
at least one memory having executable instructions stored thereon; and
one or more processors configured to execute the executable instructions to cause the processing system to:
receive an image and an input prompt specifying a colorization to apply to the image;
generate, based on an encoded version of the image and a textual description of the image input into a machine learning model, one or more color maps associated with the specified colorization to apply to the image;
generate, by the machine learning model, a colorized version of the image based on combining a greyscale version of the image and the one or more color maps; and
output the colorized version of the image.

18. The system of claim 17, wherein:
the colorized version of the image comprises a colorized version of a keyframe in video content; and
the one or more processors are further configured to cause the processing system to generate colorized versions of one or more frames subsequent to the keyframe based on colorization applied to one or more objects in the keyframe such that colorization of the one or more objects is consistent across the colorized version of the keyframe and colorized versions of the one or more frames subsequent to the keyframe.

19. The system of claim 17, wherein to generate the colorized version of the image, the one or more processors are configured to cause the processing system to:
generate, by one or more first denoising layers of the machine learning model, a combined latent representation based on combining a latent representation of the greyscale version of the image and latent representations of the one or more color maps;
process the combined latent representation through one or more second denoising layers of the machine learning model; and
decode the colorized version of the image based on an output of processing the combined latent representation through the one or more second denoising layers of the machine learning model.

20. The processing system of claim 17, wherein:
the input prompt specifying the colorization to apply to the image comprises a textual prompt specifying a color associated with one or more objects in the image; and
to generate the one or more color maps, the one or more processors are configured to cause the processing system to decompose the input prompt into a plurality of sub-prompts comprising textual prompts associated with individual objects from the one or more objects, and wherein the machine learning model is configured to process the plurality of sub-prompts substantially in parallel.
